(19) United States
(12) Patent Application Publication
(10) Pub. No.: US 2011/0025612 A1
(43) Pub. Date: Feb. 3, 2011

(54) TOUCH DISPLAY PANEL, SEALANT THEREOF, AND COMPOSITION FOR FORMING SEALANT

(75) Inventor: Yi-Hau Shiau, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/574,698

(22) Filed: Oct. 6, 2009

(30) Foreign Application Priority Data
Jul. 31, 2009 (TW) 98125932

(51) Int. Cl. G06F 3/041; C08G 59/14; C08K 3/34; C08K 3/22; C08F 2/50

(52) U.S. Cl. 345/173; 522/100; 522/71; 522/81; 522/83; 522/47; 345/173

(57) ABSTRACT

A touch display panel includes a first substrate, a second substrate, a touch-sensing structure, a display medium and a sealant. The touch-sensing structure and the display medium are sealed between the first and second substrates by the sealant. The sealant is formed by performing a polymerization reaction on a composition. The composition includes a bis-phenol A type epoxy acrylic monomer (20 to 50 weight percent (wt %)), an acrylic monomer (2 to 8 wt %), a photo-initiator reagent (0.5 to 5 wt %) and a hardener reagent (1 to 5 wt %). The acrylic monomer has a chemical formula represented as the following:

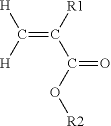

wherein R1 is selected from hydrogen or an alkyl group having 1 to 3 carbons, and R2 is selected from hydrogen or an alkyl group having 1 to 20 carbons.

### CROSS-REFERENCE TO RELATED APPLICATION

This application claims the priority benefit of Taiwan application serial no. 98125932, filed on Jul. 31, 2009. The entirety of the above-mentioned patent application is hereby incorporated by reference herein and made a part of specification.

### BACKGROUND OF THE INVENTION

1. Field of the Invention

The present invention relates to a display panel, and more particularly, to a touch display panel and a sealant thereof.

2. Description of Related Art

In the current information age, people are becoming more and more dependent on electronic devices. Electronic products such as notebook computers, mobile phones, personal digital assistants (PDAs), and digital walkmans are becoming indispensable tools in day-to-day life and work of modern people. The above-mentioned electronic products are all installed with a human-machine interface for inputting commands required by a user, so that internal systems in the electronic products automatically execute the commands. Currently, some of the most widely used input interfaces include keyboards, mice, and touch display panels.

In recent years, touch display panels have been widely applied to all sorts of electronic products, for example global positioning systems (GPSs), PDAs, cellular phones and hand-held personal computers, so as to replace conventional input devices (for example keyboards and mice). This drastic change in design not only enhances the friendliness of the human-machine interfaces of the electronic devices, but also provides more space due to the omission of the conventional input devices, so that the user browses information more conveniently.

At this current stage, touch display panels can be categorized, based on the manner in which they are driven and structural designs, into externally-attached resistive touch display panels and internally-embedded resistive touch display panels. For externally-attached resistive touch display panels, each is formed by a soft top substrate, a rigid bottom substrate and an insulating spacer. The inner surface of each of the top substrate and bottom substrate is plated with a transparent indium tin oxide (ITO) conductive thin film as a resistive layer, and an externally-attached resistive touch structure is attached to the display panel to form the externally-attached resistive touch display panel. For internally-embedded resistive touch display panel technologies, touch functions are directly integrated into manufacturing processes of the panels. An additional layer of touch glass or conductive thin film is not required. In-cell multi-touch panels may adopt low temperature polysilicon (LTPS) technologies which have higher electron mobility, thereby integrating electronic components in pixels. By using this technology, manufacturing costs are effectively lowered, and the modules are lighter, save electricity and are more durable compared with current touch display panels.

When fingers or other objects press against the top substrate which has an upper ITO film, the upper ITO film of the top substrate contacts a lower ITO film of the bottom substrate due to pressure by the fingers or other objects. In the meantime, when the upper ITO film and the lower ITO film are electrically connected, a voltage applied by a control unit on the upper ITO film is read out by the lower ITO film. By using the control unit to read out the sizes of the voltages on the upper and lower ITO films, the X and Y coordinates of the position on the resistive panel on which the fingers or objects press against are detected.

Generally, in externally-attached and internally-embedded resistive touch display panels, there is a sealant which is located at the surrounding of the display region and seals the touch sensing structure and the display medium between the first substrate and the second substrate. The sealant is disposed at the surrounding of the display region of the touch display panel. However, since conventional sealants are harder, when the user uses fingers or objects to touch the edge of the display region of the touch display panel, insensitivity of or even failure to sense the touch occurs due to influences by the sealant. Therefore, touch sensitivity of the touch display panels is greatly affected.

In order to avoid the above-mentioned problems, in conventional touch display panels, the display region is usually maintained at a distance from the position at which the sealant is disposed, so as to prevent the harder sealant from affecting sensing by the touch sensing structure. However, said method causes decrease in aperture ratio of the touch display panel and affects the touch quality and display quality of the touch display panel.

### SUMMARY OF THE INVENTION

The invention provides a touch display panel which has superb touch sensitivity.

The invention further provides a composition used to form a sealant and enabling the sealant to have a superb elastic recovery rate.

The invention further provides another composition used to form a sealant and further enabling the sealant to have a superb elastic recovery rate.

The invention provides a touch display panel which includes a first substrate, a second substrate, a touch-sensing structure, a display medium and a sealant. The second substrate is disposed opposite to the first substrate. The touch-sensing structure is disposed between the first substrate and the second substrate and has a sensing gap. The display medium is disposed between the first substrate and the second substrate and is used to display an image. The sealant is disposed between the first substrate and the second substrate and seals the touch-sensing structure and the display medium between the first substrate and the second substrate, wherein the sealant is formed by performing a polymerization reaction on a composition. The above-mentioned composition includes a bis-phenol A type epoxy acrylic monomer, an acrylic monomer, a photo-initiator reagent and a hardener reagent. The amount of the bis-phenol A type epoxy acrylic monomer is 20 to 50 weight percent (wt %). The amount of the acrylic monomer is 2 to 8 wt %, and the acrylic monomer has a chemical formula as shown in the following formula 1.

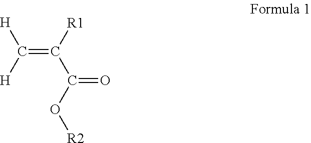

R1 is selected from hydrogen or an alkyl group having 1 to 3 carbons, and R2 is selected from hydrogen or an alkyl group having 1 to 20 carbons. The amount of the photo-initiator reagent is 0.5 to 5 wt %. The amount of the hardener reagent is 1 to 5 wt %.

The invention further provides a composition which is used to form a sealant and includes a bis-phenol A type epoxy acrylic monomer, an acrylic monomer, a photo-initiator reagent and a hardener reagent. The amount of the bis-phenol A type epoxy acrylic monomer is 20 to 50 wt %. The amount of the acrylic monomer is 2 to 8 wt %, and the acrylic monomer has a chemical formula as shown in the following formula 1.

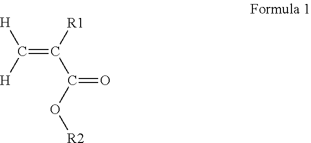

R1 is selected from hydrogen or an alkyl group having 1 to 3 carbons, and R2 is selected from hydrogen or an alkyl group having 1 to 20 carbons. The amount of the photo-initiator reagent is 0.5 to 5 wt %. The amount of the hardener reagent is 1 to 5 wt %.

The invention further provides a composition which is used to form a sealant, is suitable for a display panel, and includes an epoxy acrylic monomer, an acrylic monomer, a photo-initiator reagent and a hardener reagent. The amount of the epoxy acrylic monomer is 20 to 50 wt %. The amount of the acrylic monomer is 2 to 8 wt %, and the acrylic monomer has a chemical formula as shown in the following formula 1.

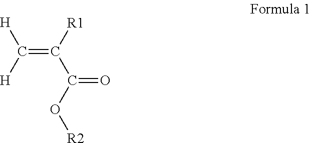

R1 is selected from hydrogen or an alkyl group having 1 to 3 carbons, and R2 is selected from hydrogen or an alkyl group having 1 to 20 carbons. The amount of the photo-initiator reagent is 0.5 to 5 wt %. The amount of the hardener reagent is 1 to 5 wt %.

The invention further provides a sealant which is polymer formed by performing a polymerization reaction on the above-mentioned composition.

In light of the above, since the acrylic monomer which has the characteristics of a soft chain is added into the composition used to form the sealant, besides retaining the original sealing characteristics of the sealant, the sealant also has elasticity and a superb elastic recovery rate. Therefore, when the sealant is applied in the touch display panel, the touch sensitivity of the touch display panel is enhanced, and when the external force exerted on the touch display panel is removed, the sealant which has the superb recovery rate is beneficial to the recovery of the pressed part to the original state, thereby preventing effects on the display quality of the touch display panel due to changes in the unit gap by external forces.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a cross-sectional view of a touch display panel according to an embodiment of the invention.

FIG. 2 shows results of testing elastic recovery rates of a sealant according to an embodiment of the invention.

FIG. 3 shows results of comparing adhesion forces of the sealant according to the above-mentioned embodiment and of a sealant according to a reference embodiment.

FIG. 4 shows results of comparing voltage holding ratios of the sealant according to the above-mentioned embodiment and of a sealant according to a reference embodiment.

### DESCRIPTION OF EMBODIMENTS

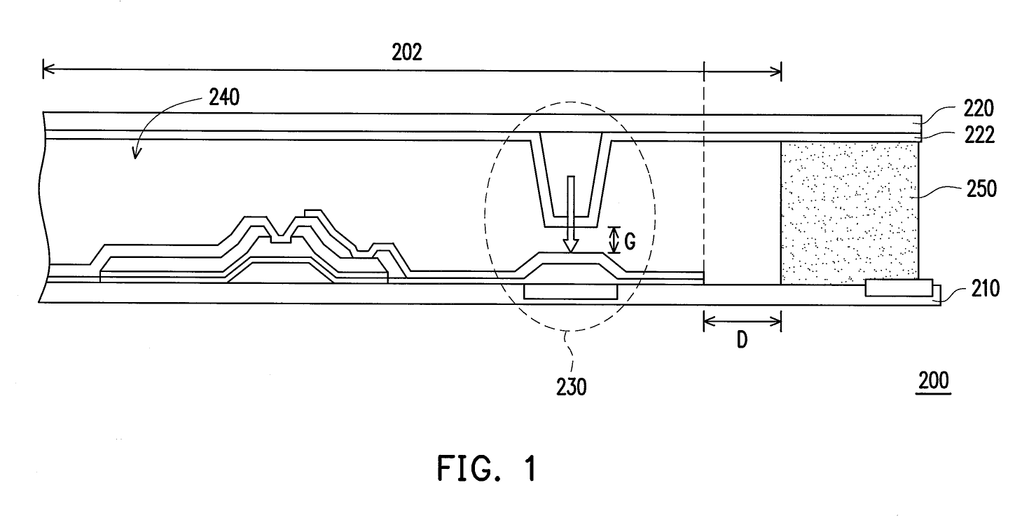

FIG. 1 shows a cross-sectional view of a touch display panel according to an embodiment of the invention. Referring to FIG. 1, a touch display panel 200 includes a first substrate 210, a second substrate 220, a touch-sensing structure 230, a display medium 240 and a sealant 250. The second substrate 220 is opposite to the first substrate 210 and has a common electrode 222 disposed thereon. The touch-sensing structure 230 is disposed between the first substrate 210 and the second substrate 220 and has a sensing gap G. The display medium 240 is sandwiched between the first substrate 210 and the second substrate 220 and is used to display an image. The sealant 250 is disposed between the first substrate 210 and the second substrate and seals the touch-sensing structure 230 and the display medium 240 between the first substrate 210 and the second substrate 220, wherein the sealant 250 is formed by performing a polymerization reaction on a composition.

In detail, the composition used to form the sealant 250 includes an epoxy acrylic monomer, an acrylic monomer, a photo-initiator reagent and a hardener reagent. The epoxy acrylic monomer is preferably a bis-phenol A type epoxy acrylic monomer, and the acrylic monomer is preferably an acrylic monomer having a soft chain. In addition, contents of each compound in the composition have the following relationship. The amount of the bis-phenol A type epoxy acrylic monomer is from 20 to 50 wt %, the amount of the acrylic monomer is from 2 to 8 wt %, the amount of the photo-initiator reagent is from 0.5 to 5 wt %, and the amount of the hardener reagent is from 1 to 5 wt %.

It should be noted that, the sealant 250 formed after performing a polymerization reaction on the composition having the above relationship is elastic and has a superb elastic recovery rate, so that the touch display panel 200 which uses said sealant has better touch sensitivity. Therefore, compared with conventional touch display panels, in a limited substrate space of a touch display panel, a designer using the sealant of the invention is able to successfully extend a range of a display region 202 closer to the position at which the sealant 250 is located. For example, according to the present embodiment, there is a display region 202 between the first substrate 210 and the second substrate 220, and a distance D between the display region 202 and the sealant 250 is less than 700 μm. Therefore, design margins such as the viewable size and resolution of the product are able to be enhanced, thereby increasing touch sensitivity and simultaneously increasing display quality.

The following further illustrates the composition and the sealant 250 formed thereby.

The composition used to form the sealant 250 includes 20 to 50 wt % of the bis-phenol A type epoxy acrylic monomer, 2 to 8% of the acrylic monomer, 0.5 to 5 wt % of the photo-initiator reagent and 1 to 5 wt % of the hardener reagent. The following individually illustrates each of the compounds in the composition.

### The Acrylic Monomer

First, the acrylic monomer in the composition is used to provide a soft chain in the main chain of the formed polymer after the polymerization reaction. In other words, the acrylic resin after polymerization is softer compared with the bis-phenol A type epoxy acrylic resin in other parts of the main chain. Therefore, the acrylic monomer in the composition provides the sealant 250 with elastic effects.

From views of polymerization reactivity and the product having a superb elastic recovery rate, the amount of the acrylic monomer added in the composition is substantially from 2 to 8 wt %. For example, when the amount of the acrylic monomer added in the composition is above 2 wt %, the acrylic monomer polymerizes with the bis-phenol A type epoxy acrylic monomer and makes the sealant 250 elastic. When the amount added is below 8 wt %, the sealant 250 is ensured to have a sufficient elastic recovery rate without affecting sealing strengths.

The acrylic monomer is not limited. Specifically, the acrylic monomer has a chemical formula as shown in the following formula 1.

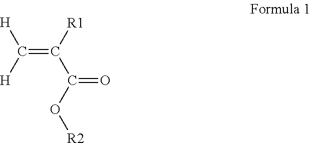

R1 is selected from hydrogen or an alkyl group having 1 to 3 carbons, and R2 is selected from hydrogen or an alkyl group having 1 to 20 carbons. In other words, the substitute group for R1 may be hydrogen, methyl group, ethyl group or propyl group. As to the reactivity of the reactants during the polymerization reaction, the substitute groups for R1 and R2 are preferably functional groups having less steric hindrance, so that the substitute group for R1 is preferably hydrogen or an alkyl group having 1 to 3 carbons, and the substitute group for R2 is preferably hydrogen or an alkyl group having 1 to 20 carbons.

### The Bis-Phenol A Type Epoxy Acrylic Monomer

The bis-phenol A type epoxy acrylic monomer in the composition is used to provide a rigid chain in the main chain of the formed polymer after the polymerization reaction. In other words, the bis-phenol A type epoxy acrylic resin after polymerization is more rigid compared with the acrylic resin in other parts of the main chain. Therefore, the bis-phenol A type epoxy acrylic monomer in the composition provides the sealant 250 with sufficient mechanical strength, so as to maintain the cell gap between the first substrate 210 and the second substrate 220 in the touch display panel 200.

The bis-phenol A type epoxy acrylic monomer is not limited. Specifically, the bis-phenol A type epoxy acrylic monomer has a chemical formula as shown in the following formula 2.

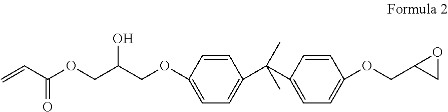

From views of polymerization reactivity and the product having sufficient mechanical strength, the amount of the bis-phenol A type epoxy acrylic monomer added in the composition is substantially from 20 to 50 wt %. For example, when the amount of the bis-phenol A type epoxy monomer added in the composition is above 20 wt %, the bis-phenol A type epoxy acrylic monomer sufficiently polymerizes with the acrylic monomer, so that the sealant 250 has sufficient mechanical strength. When amount of the bis-phenol A type epoxy acrylic monomer added is below 50 wt %, the sealant 250 is ensured to have a sufficient elastic recovery rate without affecting sealing strength.

### The Photo-Initiator Reagent.

The so-called photo-initiator reagent generates reactive substances such as free radicals through absorption of reactive light. In other words, reactive substances such as free radicals are formed in the composition through irradiation of reactive light, so that the polymerization reaction of the bis-phenol A type epoxy acrylic monomer and the acrylic monomer in the composition is initiated. From views of curing ratios and crosslinking ratios, the amount of the photo-initiator reagent added in the composition is substantially between 0.5 to 5 wt %. For example, when the amount of the photo-initiator reagent added in the composition is above 0.5 wt %, the polymerization reaction is initiated, and when the amount added is below 5 wt %, it is ensured that the hardener reagent is uniformly dissolved in the sealant. The photo-initiator reagent is not limited. For example, a material of the photo-initiator reagent includes an acetophenone compound.

Further, in the composition, the sealant 250 which has a better elastic recovery rate is obtained when the ratio of acrylic monomer to photo-initiator reagent is substantially 10:1. The elastic recovery rate of the sealant 250 is, for example, from 60% to 85%.

### The Hardener Reagent

The hardener reagent generally means a substance which promotes thermal curing reactions during the polymerization reaction of the composition. From views of operability and reactivity, the amount of the hardener reagent added in the composition is substantially from 1 to 5 wt %. For example, when the amount of the hardener reagent added in the composition is above 1 wt %, curing is promoted, and when the amount added is below 5 wt %, it is ensured that the hardener reagent is uniformly dissolved in the sealant. Specifically, a material of the hardener reagent includes a dihydrizade with a heterocyclic ring.

### The Bis-Phenol A Type Epoxy Di-Acrylic Monomer

The composition used to form the sealant 250 in the invention may further include a bis-phenol A type epoxy di-acrylic monomer, which is used as an elastomer. The bis-phenol A type epoxy di-acrylic monomer is not limited. Specifically, the bis-phenol A type epoxy di-acrylic monomer has a chemical formula as shown in the following formula 3.

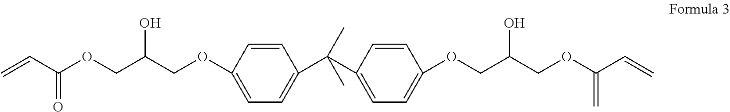

Two ends of the bis-phenol A type epoxy di-acrylic monomer are reactive ends. Compared with the above-mentioned bis-phenol A type epoxy acrylic monomer in which one end is an reactive end and another end is a terminal end, addition of the bis-phenol A type epoxy di-acrylic monomer in the composition timely assists the progression of the polymerization reaction and adjusts the molecular weight of the sealant 250. From views of the polymerization reaction and product characteristics, according to the present embodiment, the amount of the bis-phenol A type epoxy di-acrylic monomer added is substantially from 2 to 25 wt %. For example, when the amount of the bis-phenol A type epoxy di-acrylic monomer added in the composition is above 2 wt %, progression of the polymerization is assisted and the sealant 250 has sufficient mechanical strength, and when the amount added is below 25 wt %, supportability of the panel is ensured.

Through the polymerization reaction of the composition which has the above-mentioned content relationship, when the polymer formed after the polymerization reaction is used as the sealant 250, in addition to having characteristics such as retaining sufficient adhesion force and maintaining sufficient voltage holding ratios, a superb elastic recovery rate is demonstrated. Therefore when the sealant 250 is under pressure, it does not collapse or break. The elastic recovery rate of the sealant 250 is from 60% to 85%.

The designer may also timely adjust the contents of the sealant 250 according to product requirements. For example, the sealant 250 may include a filler, so as to adjust the mechanical strength of the sealant 250. Specifically, a material which may be used as the filler includes one of a group consisting of barium silicide sulfide, barium carbonate, strontium carbonate, titanium dioxide, quartz, calcium silicate, calcium carbonate, aluminum silicate, magnesium silicate, aluminum oxide, magnesium oxide, calcium oxide, kaolinite, silicon dioxide, talcum powder, aluminum nitride and boron nitride. The amount of the filler is substantially from 15 to 30 wt %. It should be noted that as long as the grain size of the filler is within a range which does not affect touch characteristics, there are no specific limitations.

In addition, the sealant 250 may further include elastic spacers, for example ball spacers or columnar photo spacers, so that the sealant 250 maintains the gap between the two substrates of the display panel. Specifically, the elastic spacers may be chosen from elastic materials, such as known spacer materials. It should be noted that as long as the size of the elastic spacers is within the range which does not affect touch characteristics, there are no specific limitations. The size of the elastic spacers is preferably equal to or less than half the overall thickness of the sealant 250.

In order to comply which design requirements of some touch display panels 200, the sealant 250 may further include elastic conductive balls, for example elastic ball spacers coated with a gold layer, so that the common electrode on the first substrate 210 and the common electrode on the second substrate 220 are electrically connected. It should be noted that as long as the size of the elastic conductive balls is within a range which does not affect touch characteristics, there are no specific limitations.

Since the acrylic monomer which has the characteristics of the soft chain is added into the composition used to form the sealant 250, besides retaining the original sealing characteristics of the sealant 250, the sealant 250 also has elasticity and a superb elastic recovery rate. Therefore, when the sealant 250 is applied in the touch display panel 200, the touch sensitivity of the touch display panel 200 is enhanced, and when the external force exerted on the touch display panel 200 is removed, the sealant 250 which has a superb recovery rate is beneficial to the recovery of the pressed part to the original state, thereby preventing effects on the display quality of the touch display panel 200 due to changes in the unit gap by external forces.

The following provides some representative embodiments to illustrate the invention, but the invention is not limited thereto.

### Embodiment 1

The amount of each compound in the composition used to form the sealant 250 is shown in Table 1. According to the present embodiment 1, the amount of bis-phenol A type epoxy acrylic monomer is 33 wt %, the amount of the acrylic monomer is 8 wt %, the amount of the photo-initiator reagent is 0.8 wt %, the amount of the hardener reagent is 4 wt %, the amount of the bis-phenol A type epoxy di-acrylic monomer is 23 wt % and the amount of the filler is 27 wt %.

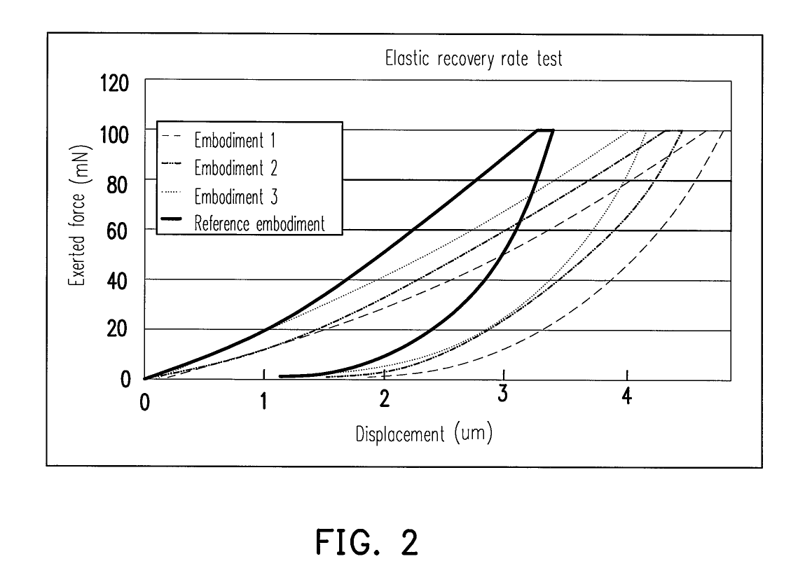

The polymer formed after a polymerization reaction of the above-mentioned composition is used as the sealant 250 in the touch display panel 200. An elastic recovery rate test is performed on the sealant 250 after photo curing and thermal curing, wherein the conditions for the elastic recovery rate test are: individually applying different loads onto the sealant 250 and measuring the amount of deformation of the sealant 250. The testing results are shown in Table 2 and FIG. 2. In addition, the displacement of the sealant 250 in the original state when no force is applied is zero, the maximum displacement of the sealant 250 when the maximum force is exerted is A, and when the force exerted on the sealant 250 is removed, the displacement of the sealant 250 relative to the original state is B. The recovery rate RR is calculated as defined in the following.

$$RR = \frac{( B - A )}{A} \times 100 \%$$

According to the above calculation, the recovery rate RR according to embodiment 1 is 83.73%.

### Embodiment 2

The amount of each compound in the composition used to form the sealant 250 is shown in Table 1. According to the present embodiment 2, the amount of bis-phenol A type epoxy acrylic monomer is 33 wt %, the amount of the acrylic monomer is 5 wt %, the amount of the photo-initiator reagent is 0.5 wt %, the amount of the hardener reagent is 4 wt %, the amount of the bis-phenol A type epoxy di-acrylic monomer is 22 wt % and the amount of the filler is 27 wt %.

The polymer formed after a polymerization reaction of the above-mentioned composition is used as the sealant 250 in the touch display panel 200. An elastic recovery rate test is performed on the sealant 250 after photo curing and thermal curing, and the testing results are shown in Table 2 and FIG. 2. The conditions for the elastic recovery rate test are the same as above, and according to the above-mentioned calculation method for the elastic recovery rate, the elastic recovery rate RR according to embodiment 2 is substantially 70.78%.

### Embodiment 3

The amount of each compound in the composition used to form the sealant 250 is shown in Table 1. According to the present embodiment 3, the amount of bis-phenol A type epoxy acrylic monomer is 33 wt %, the amount of the acrylic monomer is 2.5 wt %, the amount of the photo-initiator reagent is 0.25 wt %, the amount of the hardener reagent is 4 wt %, the amount of the bis-phenol A type epoxy di-acrylic monomer is 30.5 wt % and the amount of the filler is 27 wt %.

The polymer formed after a polymerization reaction of the above-mentioned composition is used as the sealant 250 in the touch display panel 200. An elastic recovery rate test is performed on the sealant 250 after photo curing and thermal curing, and the testing results are shown in Table 2 and FIG. 2. The conditions for the elastic recovery rate test are the same as above, and according to the above-mentioned calculation method for the elastic recovery rate, the elastic recovery rate RR according to embodiment 3 is substantially 64.45%.

### Reference Embodiment

The amount of each compound in the composition used to form the sealant 250 is shown in Table 1. According to the reference embodiment, the acrylic monomer is not added into the composition, the amount of bis-phenol A type epoxy acrylic monomer is 33 wt %, the amount of the photo-initiator reagent is 3 wt %, the amount of the hardener reagent is 4 wt %, the amount of the bis-phenol A type epoxy di-acrylic monomer is 33 wt % and the amount of the filler is 27 wt %.

The polymer formed after a polymerization reaction of the above-mentioned composition is used as the sealant 250 in the touch display panel 200. An elastic recovery rate test is performed on the sealant 250 after photo curing and thermal curing, and the testing results are shown in Table 2 and FIG. 2. The conditions for the elastic recovery rate test are the same as above, and according to the above-mentioned calculation method for the elastic recovery rate, the elastic recovery rate RR according to reference embodiment is substantially 72.88%.

TABLE 1

| Amount added | Embodi- | Embodi- | Embodi- | Reference |
|---|---|---|---|---|
| (wt %) | ment 1 | ment 2 | ment 3 | Embodiment |
| Bis-phenol A type | 33 | 33 | 33 | 33 |
| epoxy acrylic | | | | |
| monomer | | | | |
| Acrylic monomer | 8 | 5 | 2.5 | 0 |
| Photo-initiator | 0.8 | 0.5 | 0.25 | 3 |
| reagent | | | | |
| Hardener reagent | 4 | 4 | 4 | 4 |
| Bis-phenol A type | 23 | 22 | 30.5 | 33 |
| epoxy di-acrylic | | | | |
| monomer | | | | |
| Filler | 27 | 27 | 27 | 27 |

TABLE 2

| Amount | | | | |
|---|---|---|---|---|
| added | | | Embodiment | Reference |
| (wt %) | Embodiment 1 | Embodiment 2 | 3 | Embodiment |
| Elastic | 80.73% | 70.78% | 64.45% | 71.71% |
| recovery | | | | |
| rate | | | | |

FIG. 2 shows results of testing elastic recovery rates of a sealant according to an embodiment of the invention, wherein the X axis represents the displacement of the sealant, and the Y axis represents the force exerted on the sealant. Referring to FIG. 2, through the addition of a suitable amount of the acrylic monomer in the composition for forming the sealant, the sealant which is more elastic is formed. Compared with the reference embodiment, the sealants according to embodiments 1, 2 and 3 uniformly shift towards the right. In other words, under the same exerted force, the sealants according to embodiments 1, 2 and 3 have greater displacement. In addition, when the exerted force is removed, the sealants according to embodiments 1, 2 and 3 have better elastic recovery rates.

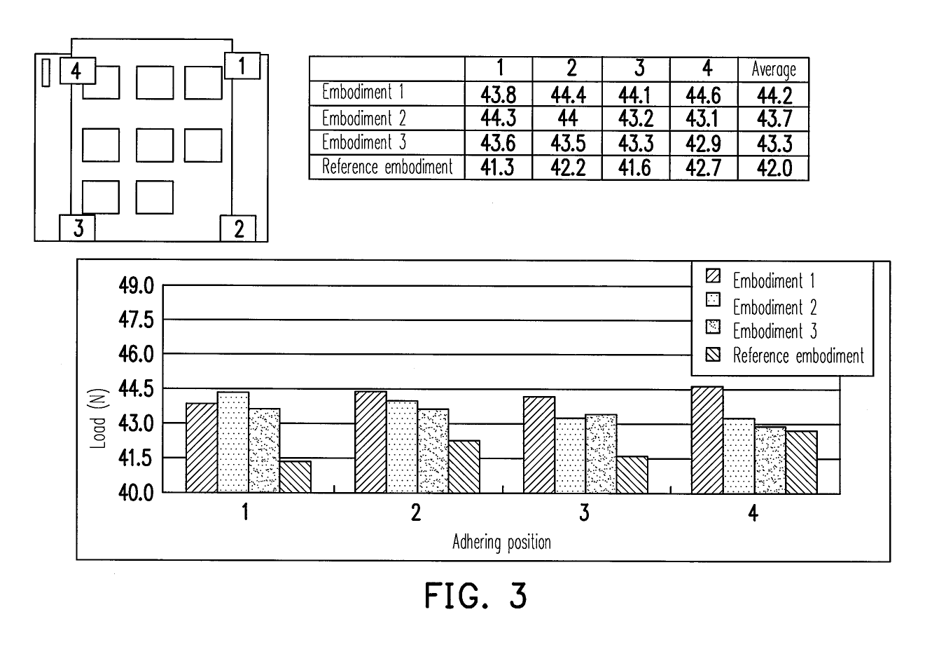

FIG. 3 shows results of comparing adhesion forces of the sealants according to the above-mentioned embodiments and of the sealant according to the reference embodiment. The conditions for the adhesion force test are: exerting an external force of 100 mN, maintaining the force for 5 seconds, and releasing the external force of 100 mN. The testing results are shown in FIG. 3. Please refer to FIG. 3, wherein 1, 2, 3 and 4 respectively represent adhesion force tests at different positions on the substrate. As shown in FIG. 3, the difference in performance of the sealants according to embodiments 1, 2 and 3 and according to the reference embodiment is almost negligible. Therefore, while retaining the same level of adhesion force, the sealant of the invention further provides elastic functions and superb elastic recovery rates.

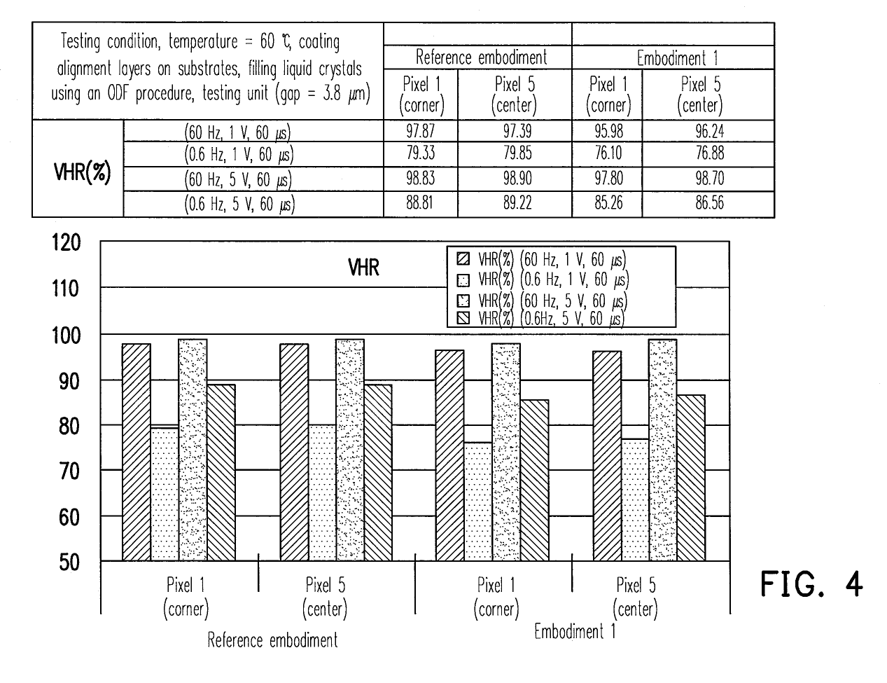

FIG. 4 shows results of comparing voltage holding ratios of the sealants according to the above-mentioned embodiments and of the sealant according to the reference embodiment. The conditions for the voltage holding ratio test are: under a temperature of 60° C., coating alignment layers on the substrates, filling the liquid crystals using a one drop fill (ODF) procedure, and individually testing the voltage holding ratios at conditions of 60 Hz and 0.6 Hz. The testing results are shown in FIG. 4, wherein a pixel 1 and a pixel 5 are respectively located at the corner and the center of the touch display panel. Referring to FIG. 4, the difference in performance in the voltage holding ratios of the sealants according to embodiments 1, 2 and 3 and the sealant according to the reference embodiment is almost negligible. Therefore, while retaining the same level of voltage holding ratio, the sealant of the invention further provides elastic functions and superb elastic recovery rates.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch display panel, comprising:
a first substrate;
a second substrate disposed opposite to the first substrate;
a touch-sensing structure, disposed between the first substrate and the second substrate, the touch-sensing structure having a sensing gap;
a display medium, disposed between the first substrate and the second substrate and used to display an image; and
a sealant, disposed between the first substrate and the second substrate and sealing the touch-sensing structure and the display medium between the first substrate and the second substrate, wherein the sealant is formed by performing a polymerization reaction on a composition, the composition comprising:
a bis-phenol A type epoxy acrylic monomer, an amount thereof being 20 to 50 weight percent (wt %);
an acrylic monomer, an amount thereof being 2 to 8 wt %, said acrylic monomer having a chemical formula as shown in a following formula 1: 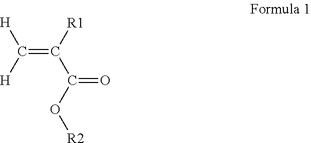
wherein R1 is selected from hydrogen or an alkyl group having 1 to 3 carbons, and R2 is selected from hydrogen or an alkyl group having 1 to 20 carbons;
a photo-initiator reagent, an amount thereof being 0.5 to 5 wt %; and
a hardener reagent, an amount thereof being 1 to 5 wt %.

2. The touch display panel of claim 1, wherein the sealant further comprises a bis-phenol A type epoxy di-acrylic monomer, an amount thereof being 2 to 25 wt %.

3. The touch display panel of claim 1, wherein the sealant further comprises a filler, an amount thereof being 15 to 30 wt %.

4. The touch display panel of claim 3, wherein a material of the filler is selected from the group consisting of barium silicide sulfide, barium carbonate, strontium carbonate, titanium dioxide, quartz, calcium silicate, calcium carbonate, aluminum silicate, magnesium silicate, aluminum oxide, magnesium oxide, calcium oxide, kaolinite, silicon dioxide, talcum powder, aluminum nitride and boron nitride.

5. The touch display panel of claim 1, wherein the photo-initiator reagent comprises an acetophenone compound.

6. The touch display panel of claim 1, wherein the hardener reagent comprises a dihydrizade with a heterocyclic ring.

7. The touch display panel of claim 1, wherein a ratio of the acrylic monomer to the photo-initiator reagent is 10:1.

8. The touch display panel of claim 1, wherein an elastic recovery rate of the sealant is from 60% to 85%.

9. The touch display panel of claim 1, wherein the first substrate and the second substrate have a display region, and a distance between the display region and the sealant is less than 700 μm.

10. The touch display panel of claim 1, wherein the sealant further comprises an elastic spacer.

11. The touch display panel of claim 1, wherein the sealant further comprises an elastic conductive ball.

12. A composition used to form a sealant which is suitable for a display panel, comprising:
a bis-phenol A type epoxy acrylic monomer, an amount thereof being 20 to 50 wt %;
an acrylic monomer, an amount thereof being 2 to 8 wt %, said acrylic monomer having a chemical formula as shown in a following formula 1: 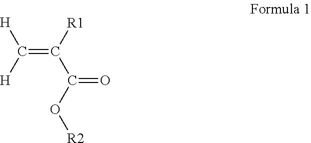
wherein R1 is selected from hydrogen or an alkyl group having 1 to 3 carbons, and R2 is selected from hydrogen or an alkyl group having 1 to 20 carbons;
a photo-initiator reagent, an amount thereof being 0.5 to 5 wt %; and
a hardener reagent, an amount thereof being 1 to 5 wt %.

13. The composition used to form the sealant of claim 12, further comprising a bis-phenol A type epoxy di-acrylic monomer, an amount thereof being 2 to 25 wt %.

14. The composition used to form the sealant of claim 12, further comprising a filler, an amount thereof being 15 to 30 wt %.

15. The composition used to form the sealant of claim 14, wherein a material of the filler is selected from the group consisting of barium silicide sulfide, barium carbonate, strontium carbonate, titanium dioxide, quartz, calcium silicate, calcium carbonate, aluminum silicate, magnesium silicate, aluminum oxide, magnesium oxide, calcium oxide, kaolinite, silicon dioxide, talcum powder, aluminum nitride and boron nitride.

16. The composition used to form the sealant of claim 12, wherein the photo-initiator reagent comprises an acetophenone compound.

17. The composition used to form the sealant of claim 12, wherein the hardener reagent comprises a dihydrizade with a heterocyclic ring.

18. The composition used to form the sealant of claim 12, wherein a ratio of the acrylic monomer to the photo-initiator reagent is 10:1.

19. A sealant, formed by performing a polymerization reaction on the composition of claim 13.

20. The sealant of claim 19, wherein an elastic recovery rate of the sealant is from 60% to 85%.

21. A composition used to form a sealant which is suitable for a display panel, comprising:
an epoxy acrylic monomer, an amount thereof being 20 to 50 weight percent (wt %);
an acrylic monomer, an amount thereof being 2 to 8 wt %, said acrylic monomer having a chemical formula as shown in a following formula 1: 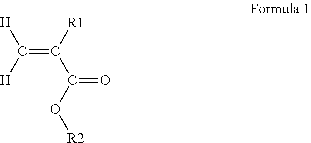
wherein R1 is selected from hydrogen or an alkyl group having 1 to 3 carbons, and R2 is selected from hydrogen or an alkyl group having 1 to 20 carbons;
a photo-initiator reagent, an amount thereof being 0.5 to 5 wt %; and
a hardener reagent, an amount thereof being 1 to 5 wt %.
